(19) United States
(12) Patent Application Publication
(10) Pub. No.: US 2019/0154790 A1
(43) Pub. Date: May 23, 2019

(54) METHOD FOR DETERMINING A RECEPTION DIRECTION OF A RADIO SIGNAL

(71) Applicant: Continental Teves AG & Co. oHG, Frankfurt am Main (DE)

(72) Inventor: Sebastian Strunck, Niedernhausen (DE)

(21) Appl. No.: 16/320,624

(22) PCT Filed: Jul. 26, 2017
(86) PCT No.: PCT/DE2017/200074

§ 371 Date: Jan. 25, 2019

(30) Foreign Application Priority Data
Aug. 1, 2016 (DE) 10 2016 214 142.2

(51) Int. Cl. G01S 3/34; G01S 3/06; G01S 3/12; G01S 3/36

(52) U.S. Cl. CPC G01S 3/34; G01S 3/36; G01S 3/12; G01S 3/06

(57) ABSTRACT

A method for determining a reception direction of a radio signal, wherein several antennas having different directional characteristics are used.

### CROSS REFERENCE TO RELATED APPLICATIONS

This application is the U.S. National Phase Application of PCT International Application No. PCT/DE2017/200074, filed Jul. 26, 2017, which claims priority to German Patent Application No. 10 2016 214 142.2, filed Aug. 1, 2016, the contents of such applications being incorporated by reference herein.

### FIELD OF THE INVENTION

The invention relates to a method for determining a reception direction of a radio signal.

### BACKGROUND OF THE INVENTION

The determination of a position of a vehicle is essential for automatic navigation. The determination of the position by means of satellite navigation systems, such as for example GPS, without further aids is typically only able to position a vehicle to an accuracy of about seven meters. This is typically not sufficient for modern applications such as lane detection.

An improvement of position determination can be achieved by means of different aids, such as for example differential GPS. In this approach, fixed GPS receivers are used, the position of which is known. They serve to calculate correction values, which are based on a difference between the measured and the actual position and are forwarded to mobile GPS users.

In the context of vehicle-to-X communication, which will be introduced in the future, ideally all vehicles and even pedestrians should act as users of a vehicle-to-X communication system. To this end, typically at regular intervals, all users emit so-called Cooperative Awareness Messages (CAM). These typically include a temporary identification as well as position, direction and speed information.

Although such messages include information about a position of a particular vehicle-to-X user, it is still desirable to have a more precise indication of the direction and perhaps also the distance of a transmitting user than is achievable based on the accuracies which are possible using satellite navigation. This holds particularly true for short distances.

### SUMMARY OF THE INVENTION

An aspect of the invention is to provide measures by means of which such information can be obtained.

An aspect of the invention relates to a method for determining a reception direction of a radio signal, including the steps of
receiving the radio signal by means of a first antenna having a first reception characteristic, and simultaneously generating a first reception signal,
receiving the radio signal by means of a second antenna having a second reception characteristic, and simultaneously generating a second reception signal, wherein the second reception characteristic is different from the first reception characteristic, and
identifying the reception direction based on the first reception signal and the second reception signal.

The method according to an aspect of the invention allows for a simple calculation of a reception direction, which can be identified independently of positions that are contained in messages or are determined in any other way using satellite navigation or other navigation technologies. This enables a vehicle or another vehicle-to-X user carrying out the method to determine the direction of another vehicle-to-X user by themselves, and said direction can be more precise, in particular in the case of short distances between the users, than a direction based on rather imprecise satellite navigation data.

However, it should be understood that the method is not limited to use in the context of vehicle-to-X communication but can be used to determine a reception direction of a radio signal in general.

It should be understood that the radio signal is typically the signal which propagates through space in the form of electromagnetic waves. A reception signal is typically the signal which is present in an electric conductor or any other connection after reception by the associated antenna and which can be analyzed by suitable electric or electronic circuits.

The reception direction can in particular be identified in two dimensions on the earth's surface. A longitudinal axis of a vehicle or a direction of travel can serve as a reference, for example. However, other references are also possible.

According to an advantageous embodiment, the first antenna has an omnidirectional characteristic as a reception characteristic. This allows for a direction-independent determination of the strength of a radio signal.

According to an advantageous embodiment, the second antenna has a directional characteristic as a reception signal. This is particularly advantageous in conjunction with an omnidirectional characteristic as a reception characteristic of the first antenna. In particular if two different reception characteristics of the two antennas are used, it is possible to identify the reception direction by a suitable calculation.

According to a preferred embodiment, the reception direction is identified based on respective powers of the first reception signal and the second reception signal. Examples of such a calculation will be given further below.

According to an embodiment, the reception direction is identified with an uncertainty regarding a limited number of transformations, in particular reflections and/or rotations. This may in particular mean that for example an angle relative to a reference axis is determined, but that it cannot be determined whether the angle has a positive or negative sign in a two-dimensional coordinate system on the earth's surface. Therefore in this case it can for example be established that a signal comes from ahead and from the side but not whether it comes from the left or right. This can in particular be the case if only two antennas are used. However, even in this case it is said that a reception direction is identified, although this direction includes such an uncertainty.

According to a preferred embodiment, the method further includes the step of
receiving the radio signal by means of a third antenna having a third reception characteristic, and simultaneously generating a third reception signal,
wherein the reception direction is also identified based on the third reception signal.

The use of a third antenna typically allows the reception direction of the radio signal in a two-dimensional coordinate system to be determined without any remaining uncertainty if suitable reception characteristics are selected.

The third reception characteristic preferably corresponds to the second reception characteristic, rotated about a vertical axis.

According to a preferred embodiment, the method further includes the step of
receiving the radio signal by means of a fourth antenna having a fourth reception characteristic, and simultaneously generating a fourth reception signal,
wherein the reception direction is also identified based on the fourth reception signal.

The use of a fourth antenna allows to improve accuracy even further and/or to reduce uncertainty even more.

This reception characteristic preferably corresponds to the second reception characteristic, rotated about a vertical axis. In particular, the second, third and fourth reception characteristics can correspond to each other such that they start from a common point and are rotated to each other by 120° in each case. In this way accuracy can be improved and the reduction of uncertainty can be optimized towards all sides.

Preferably the reception direction is identified unambiguously and/or without uncertainty. This is typically possible if at least three antennas are used, particularly preferably if four or even five antennas are used. In this way the aforementioned uncertainty regarding rotations, reflections or other transformations can advantageously be avoided, so that it can be precisely identified from which direction the radio signal comes.

It should be understood that even more antennas, for example a fifth antenna, can be used. The statements made immediately above hold true here as well.

The respective reception characteristics can for example be implemented as a formula and/or numerically in each case. This allows for easy calculation of the reception direction.

According to a preferred embodiment, a distance of a source emitting the radio signal is further identified based on a power of at least one of the reception signals, in particular the first reception signal. Such a power for calculating the distance can in particular be determined using an antenna which has an omnidirectional characteristic since the direction is irrelevant if only the power is determined. In this way a distance of the transmitting unit can be determined in addition to the reception direction, so that for example a collision risk can be identified during further processing in the context of vehicle-to-X communication or other driving safety technologies.

According to a further development, the method is carried out using at least a first radio signal and a second radio signal, wherein a change in a distance of a source emitting the radio signals is identified based on associated reception signals, in particular first reception signals, in particular based on a free-space path loss. In this way a relative speed of the receiving station and the transmitting station to each other can be determined, which can indicate a potential impending collision, for example.

The reception direction can further be identified based on a position information contained in the radio signal. Such a position information can for example be based on satellite navigation. This enables two approaches for determining the reception direction to be combined, wherein for example a position, determined by means of satellite navigation or otherwise, of the receiving unit, which typically carries out the method according to an aspect of the invention, can be taken into account. For example a plausibility check can be performed in this way.

According to a further development, a distance or a change in distance is identified based at least partly on a phase position of at least a first radio signal and a second radio signal. In this way the phases of the radio signals can be utilized as well, which may also mean a significant increase of the accuracy of a distance measurement or a measurement of a change in distance since the wavelengths used are typically rather short.

The antennas can in particular be arranged vertically on top of each other. This typically obviates the need for calculations to remove effects resulting solely from the different distances of the antennas.

To carry out a method according to an aspect of the invention, typically an omnidirectional antenna and one or more directional antennas are used to receive radio signals. Such a radio signal can in particular be a vehicle-to-X message or a vehicle-to-X signal.

An omnidirectional antenna alone can already detect a change in signal level and therefore indicate a possible change in distance of the transmitter. This information can for example be used to support positioning data from a Cooperative Awareness Message (CAM). Such information concerning a change in distance, together with the positioning data and averaged over time, can lead to obtaining exact knowledge about the radio channel, so that the absolute distance becomes determinable using the reception power.

Directional antennas further serve to identify the direction of the transmitter in conjunction with the reception power of an omnidirectional antenna. Thanks to the directional characteristic of one or more directional antennas, a distance vector from the reception antenna of the own vehicle can be established in this way. To this end the difference in the reception power is correlated with the known reception characteristics, typically in relation to the omnidirectional antenna. However, with just one directional antenna, typically no unambiguous result is obtained.

A change in the overall power level, which is an indication of the change in distance, can for example be calculated using a free-space path loss. This can be determined by means of the formula

F=((4πr)/(λ))²

wherein r represents the distance between the transmitter and the receiver and λ represents the wavelength of the emitted signal. The potential new distance can be calculated using the power difference between two messages and the last assumed distance. A higher accuracy can be expected if in addition the phase positions are taken into account. If four or more directional antennas are used, even a 360° coverage can be achieved. The design could for example include a dipole having an omnidirectional characteristic and four additional patch antennas offset by 90°. In the event that the omnidirectional antenna has no uniformly round directional characteristic in the azimuth level, the compensation can be determined using the direction detection with the aid of the directional antenna.

In particular, the accuracy of positioning other objects can be improved by means of the approach described herein. There is in particular an advantage in that an existing communication channel can be used passively and the measured values can be compared with the message which is received. To this end it may be necessary to expand the reception path by adding one or more antennas and corresponding power meters. The latter can be designed to measure only effective power using so-called detector diodes.

A system for detecting distances is for example radar, which can measure very precise distances. However, this is a separate system which also does not allow for an analysis of the communication data as it is not necessarily clear whether one of the objects detected by radar belongs to a vehicle-to-X message. Nevertheless, information which has been received by means of radar can be combined or fused with information obtained by the method described herein. The same holds true for other active localization methods, such as for example LiDAR, ultrasound or camera-based localization.

An aspect of the invention further relates to a system which is configured to carry out a method according to an aspect of the invention. Such a system can in particular include a corresponding plurality of antennas and an electronic control device which is configured to carry out the method according to an aspect of the invention. The electronic control device can for example include processor means and storage means to this end, wherein program code is stored in the storage means, which, when executed, causes the processor means to carry out a method according to an aspect of the invention. As regards the method according to an aspect of the invention, all embodiments and variants described above can be utilized.

An aspect of the invention further relates to a non-volatile computer-readable storage medium on which program code is stored, which, when executed, causes a processor to carry out a method according to an aspect of the invention. As regards the method according to an aspect of the invention, all embodiments and variants described above can be utilized.

### BRIEF DESCRIPTION OF THE DRAWINGS

Further features and advantages will be apparent to those skilled in the art from the exemplary embodiment described below with reference to the accompanying drawing, in which:

FIG. 1 shows reception characteristics of an omnidirectional antenna and a directional antenna,

FIG. 2 shows reception characteristics of an omnidirectional antenna and four directional antennas,

FIG. 3 shows reception characteristics of an omnidirectional antenna and an alternative directional antenna,

FIG. 4 shows reception characteristics of an omnidirectional antenna and three directional antennas,

FIG. 5 shows an arrangement in which the method according to an aspect of the invention can be carried out.

### DETAILED DESCRIPTION OF THE PREFERRED EMBODIMENTS

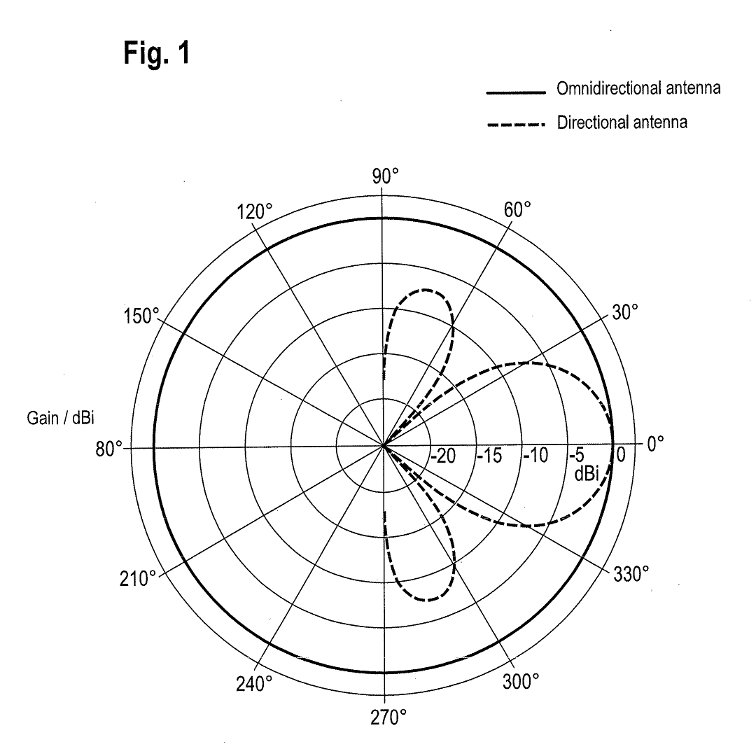

FIG. 1 shows directional characteristics of an omnidirectional antenna and a directional antenna. It can be clearly seen that the omnidirectional antenna has a uniform reception characteristic towards all sides. In contrast, the directional antenna has a reception characteristic which includes three bulges. The difference between the two reception characteristics can be used to determine the reception direction of a signal, although this reception direction may still include an uncertainty.

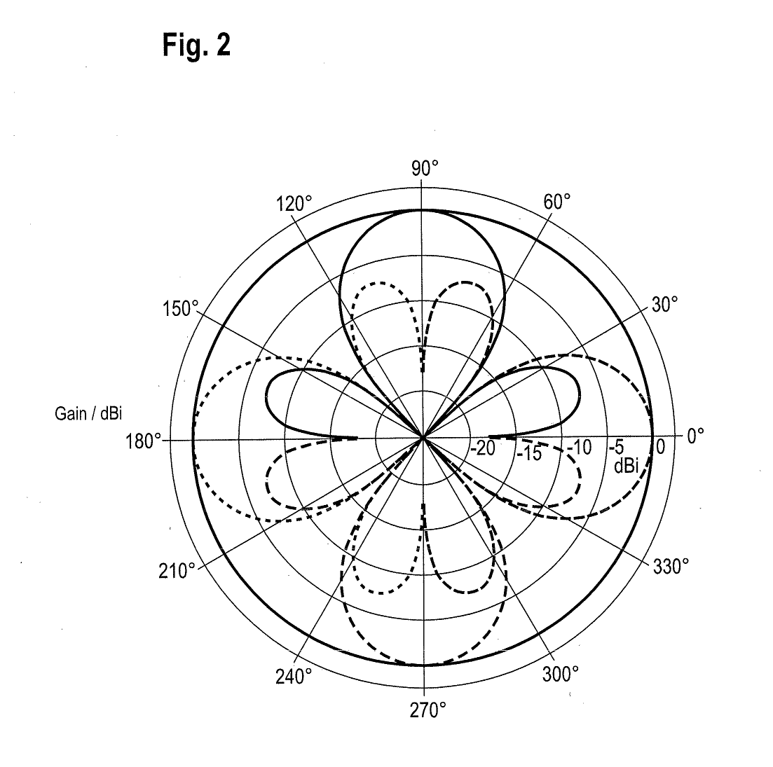

FIG. 2 shows an arrangement with a total of four directional antennas and one omnidirectional antenna, where again the respective reception characteristics are shown. The directional antennas each have the same reception characteristic as the directional antenna illustrated in FIG. 1. As the reception characteristics of the directional antennas overlap, it is possible to determine the reception direction of a radio signal without uncertainty and with very high accuracy.

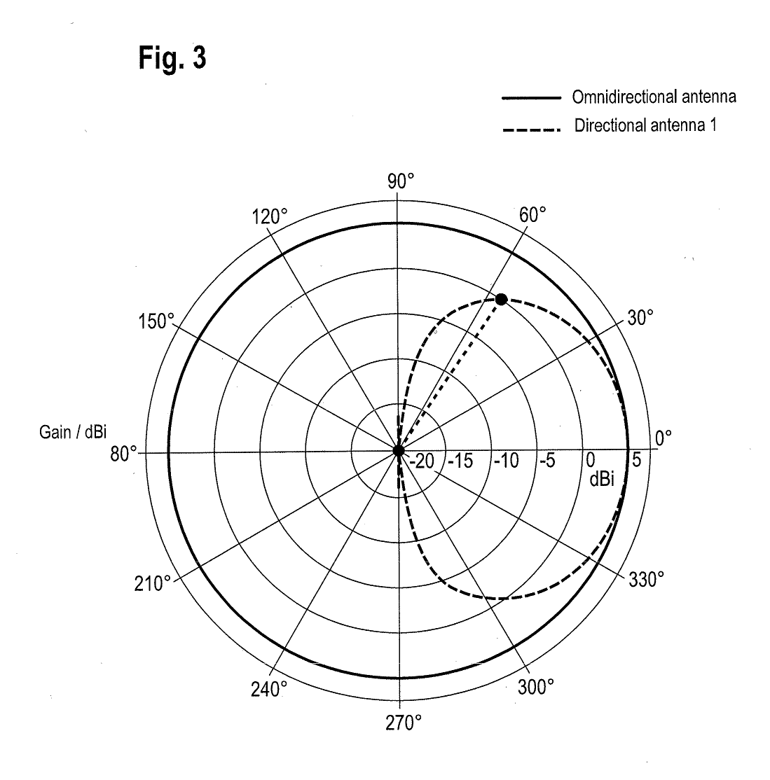

FIG. 3 shows reception characteristics of an omnidirectional antenna and a directional antenna which is designed differently from those the reception characteristics of which are illustrated in FIGS. 1 and 2. The reception characteristic shown in FIG. 3, which is labeled “directional antenna 1” in the figure, is not a reception characteristic having three bulges but with a one-sided continuous configuration of the reception characteristic.

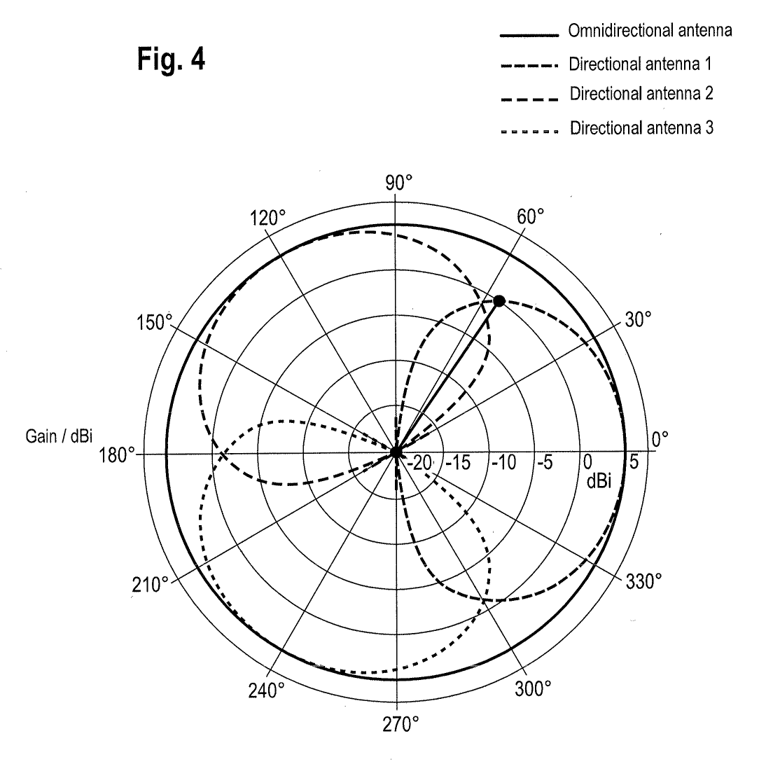

FIG. 4 shows reception characteristics of an omnidirectional antenna and three directional antennas, which are labeled “directional antenna 1”, “directional antenna 2” and “directional antenna 3”, wherein the reception characteristics of the directional antennas are identical to that illustrated in FIG. 4. These antennas also allow for precise determination of a reception direction of a radio signal without uncertainty or ambiguity.

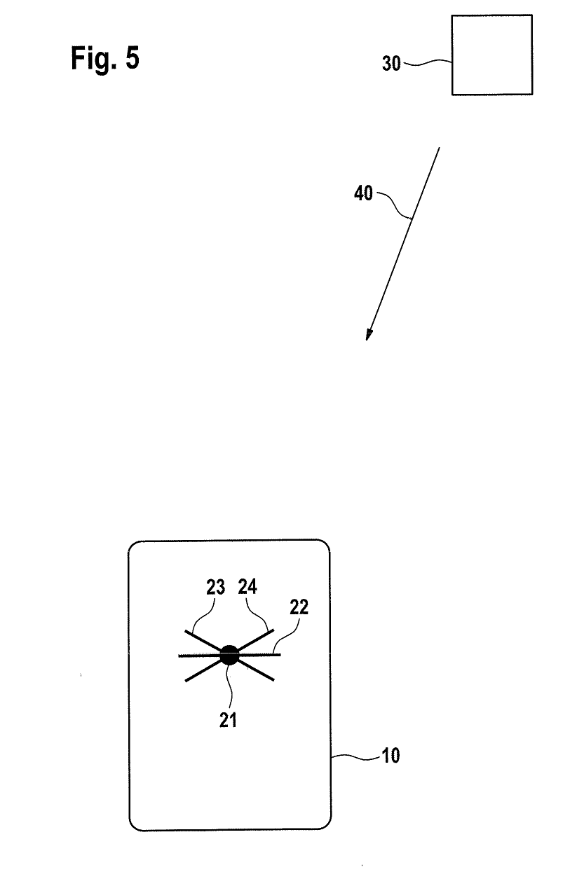

FIG. 5 schematically shows an arrangement for carrying out an exemplary embodiment of the method according to an aspect of the invention. A vehicle 10 is illustrated only schematically, including a total of four antennas, specifically a first antenna 21, a second antenna 22, a third antenna 23 and a fourth antenna 24.

Said first antenna 21 is designed as a vertical dipole, so that it has an omnidirectional characteristic as a reception characteristic in the horizontal plane. In contrast, the second, third and fourth antennas 22, 23, 24 are designed as horizontal dipoles which are rotated by 120° to each other, so that they have reception characteristics similar to those shown in FIG. 4. This arrangement generally allows for precise determination of a reception direction of a radio signal.

FIG. 5 further schematically illustrates a transmitter 30, which may for example be a mobile phone. The transmitter 30 emits a radio signal 40 which is received by the antennas 21, 22, 23, 24 of the vehicle 10. As the radio signal 40 is received by the total of four antennas 21, 22, 23, 24 with different signal strengths and the directional characteristics of the four antennas 21, 22, 23, 24 are known, it is possible to calculate the reception direction of the radio signal 40. This is explained below by way of example.

Below, an exemplary calculation with a directional antenna and an omnidirectional antenna to identify the reception direction is given, which is based on the arrangement shown in FIG. 5 and the diagram of reception characteristics shown in FIG. 4.

A reception power of the omnidirectional antenna is assumed to be P_{Ru}=−50 dBm and a reception power of the directional antenna is assumed to be P_{Rl}=−55 dBm.

The following formula is assumed as the directional characteristic of the omnidirectional antenna:

D_{Ru}(α)=0 dB.

The following formula is assumed as the directional characteristic of the directional antennas:

D_{Rl}(α)=10 log 10(cos(α)²).

The directional characteristic of such a directional antenna approximately corresponds to that of a patch antenna. The assumed directional characteristic of the omnidirectional antenna approximately corresponds to the directional characteristic of a dipole or monopole.

Now the difference between the two reception powers, which is P_{Ru}−P_{Ri}=5 dB, is to be expressed in terms of the directional characteristic. Therefore the following holds true:

P_{Ru}−P_{Rl}=D_{Ru}(α)−D_{Ri}(α)=5 dB,

which, if D_{Ru}(α)=0 dB,

leads to

$$10 \frac{- ( {P}_{Ru} - {P}_{Ri} )}{10} = {cos ( α )}^{2}$$

P_{Ru}−P_{Rl}=−10 log 10(cos(α)²). With the aid of the calculation rule

$$cos {x}^{2} = \frac{1}{2} ( 1 + cos 2 x ) ,$$

the right term can be resolved. The result is:

$$10 \frac{- ( {P}_{Ru} - {P}_{Ri} )}{10} = \frac{1}{2} ( 1 + cos 2 α ) ,$$

whereafter the cos term

$$2 \cdot 10 \frac{- ( {P}_{Ru} - {P}_{Ri} )}{10} - 1 = cos 2 α$$

can be isolated. Subsequently, the equation can be resolved to give α, that is the angle, by means of the arc cosine.

After the equation is resolved to give α, the result is:

$$α = \frac{1}{2} {cos}^{- 1} ( 2 \cdot {10}^{\frac{- 5 dB}{10}} - 1 )$$

This means, an angle of α=55.78° is calculated for a reception power of 5 dB.

It is to be understood that, if only one directional antenna is used as has been done in the exemplary calculation just made, there is still an uncertainty regarding the reception direction, i.e. the radio signal 40 may come from the left or right relative to a central axis of the directional antenna and this would not be distinguishable. This uncertainty can be resolved by making corresponding calculations using the other antennas, so that the reception direction can be determined without ambiguity.

The aforementioned steps of the method according to an aspect of the invention can be carried out in the given order. However, they can also be carried out in a different order. In one of its embodiments, for example including a particular combination of steps, the method according to an aspect of the invention can be carried out in such a manner that no further steps are carried out. However, in principle further steps can be carried out, even steps which are not mentioned.

In general it should be noted that vehicle-to-X communication means in particular direct communication between vehicles and/or between vehicles and infrastructure facilities. It can therefore be vehicle-to-vehicle communication or vehicle-to-infrastructure communication, for example. If throughout this application reference is made to communication between vehicles, this can in principle be realized for example as vehicle-to-vehicle communication, which typically takes place without transfer via a mobile phone network or a similar external infrastructure and which should therefore be distinguished from other solutions, which are for example based on a mobile phone network. Vehicle-to-X communication can take place using the IEEE 802.11p or IEEE 1609.4 standards, for example. Vehicle-to-X communication can also be referred to as C2X communication. The subfields can be referred to as C2C (Car-to-Car) or C2I (Car-to-Infrastructure). However, an aspect of the invention does explicitly not exclude vehicle-to-X communication with transfer, for example via a mobile phone network.

The claims belonging to the application are not a waiver to achieve broader protection. If it turns out during the procedure that a feature or a group of features is not absolutely necessary, it is already now the applicant's intention to formulate at least an independent claim which does no longer include the feature or the group of features. This may be for example a sub-combination of a claim existing on the filing date or a sub-combination of a claim existing on the filing date, which is limited by further features. Such reformulated claims or combinations of features should be understood as covered by the disclosure of this application.

It should further be noted that configurations, features and variants of aspects of the invention which are described in the different embodiments or exemplary embodiments and/or shown in the figures can be arbitrarily combined with each other. Individual or several features can be arbitrarily exchanged with each other. Any resulting combinations of features should be understood as covered by the disclosure of this application.

References back to dependent claims should not be understood as a waiver to achieve independent material protection for the features of the subclaims reference is made to. These features can also be arbitrarily combined with other features.

Features which are only disclosed in the description or features which are disclosed in conjunction with other features, either in the description or in any claim, can in principle be of essential importance to aspects of the invention by themselves. They can therefore also be included in any claim individually for differentiation from the state of the art.

1. A method for determining a reception direction of a radio signal, comprising:
receiving the radio signal by a first antenna having a first reception characteristic, and simultaneously generating a first reception signal,
receiving the radio signal by a second antenna having a second reception characteristic, and simultaneously generating a second reception signal, wherein the second reception characteristic is different from the first reception characteristic, and
identifying the reception direction based on the first reception signal and the second reception signal,
wherein the reception direction is further identified based on a position information contained in the radio signal.

2. The method according to claim 1,
wherein the first antenna has an omnidirectional characteristic as a reception characteristic.

3. The method according to claim 1,
wherein the second antenna has a directional characteristic as a reception characteristic.

4. The method according to claim 1,
wherein the reception direction is identified based on respective powers of the first reception signal and the second reception signal.

5. The method according to claim 1,
wherein the reception direction is identified with an uncertainty regarding a limited number of transformations, in particular reflections and/or rotations.

6. The method according to claim 1, further comprising:
receiving the radio signal by a third antenna having a third reception characteristic, and simultaneously generating a third reception signal,
wherein the reception direction is also identified based on the third reception signal.

7. The method according to claim 6,
wherein the third reception characteristic corresponds to the second reception characteristic, rotated about a vertical axis.

8. The method according to claim 6, further including the step of
receiving the radio signal by a fourth antenna having a fourth reception characteristic, and simultaneously generating a fourth reception signal,
wherein the reception direction is also identified based on the fourth reception signal.

9. The method according to claim 8,
wherein the fourth reception characteristic corresponds to the second reception characteristic, rotated about a vertical axis.

10. The method according to claim 6,
wherein the reception direction is identified unambiguously and/or without uncertainty.

11. The method according to claim 1,
wherein the reception characteristics are implemented as a formula and/or numerically in each case.

12. The method according to claim 1,
wherein a distance of a source emitting the radio signal is further identified based on a power of at least one of the reception signals, in particular the first reception signal.

13. The method according to claim 1,
wherein the method is carried out using at least a first radio signal and a second radio signal,
and wherein a change in a distance of a source emitting the radio signals is identified based on associated reception signals, in particular first reception signals, in particular based on a free-space path loss.

14. (canceled)

15. The method according to claim 1,
wherein the antennas are arranged vertically on top of each other.

16. The method according to claim 7, further comprising:
receiving the radio signal by a fourth antenna having a fourth reception characteristic, and simultaneously generating a fourth reception signal,
wherein the reception direction is also identified based on the fourth reception signal.
